(19) United States
(12) Patent Application Publication
(10) Pub. No.: US 2008/0010403 A1
(43) Pub. Date: Jan. 10, 2008

(54) RAID apparatus, module therefor, disk incorporation appropriateness judgment method and program

(75) Inventors: Koichi Tsukada, Kawasaki (JP); Satoshi Yazawa, Kawasaki (JP); Shoji Oshima, Kawasaki (JP); Tatsuhiko Machida, Kawasaki (JP); Hirokazu Matsubayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/588,230

(22) Filed: Oct. 27, 2006

(30) Foreign Application Priority Data
Jun. 16, 2006 (JP) 2006-168110

(51) Int. Cl. G06F 13/28; G06F 13/00

(52) U.S. Cl. 711/114

(57) ABSTRACT

A disk incorporation process unit 54 shares information (i.e., a common table) managed by a disk statistics unit 53 and judges whether or not to permit an incorporation of an installed disk by referring to the common table in the event of a discretionary disk having been isolated followed by the aforementioned disk being installed.

### BACKGROUND OF THE INVENTION

1. Field of the Invention

The present invention relates to a RAID (Redundant Array of Inexpensive Disks) apparatus.

2. Description of the Related Art

In the case of a necessity of replacing a disk arising, such as an occurrence of a disk failure in a conventional RAID apparatus, a hot swap of the disk is carried out by purchasing maintenance parts anew. A RAID apparatus stores and manages a Disk World Wide Name (WWN) of each of the equipped disks, and when a hot swap is carried out, only a disk having a Disk WWN which is unregistered in the RAID apparatus is a target of build-in. This is for preventing a failed disk from being built in again. A control configuration is such that, if a disk having the same Disk WWN as one prior to the replacement is installed in a RAID apparatus, the disk cannot be a build-in target. That is, a disk once installed in a RAID apparatus cannot be installed in the same RAID apparatus again.

FIGS. 1A and 1B exemplify a conventional hot swap control. FIGS. 1A and 1B show an example of a disk B failure among a plurality of disks A through E equipped in a RAID apparatus. In this case, the example shown in FIG. 1A removes the disk B to be replaced by a new disk F and the RAID apparatus performs a build-in of the disk F. Comparably, the example shown in FIG. 1B removes the disk B, followed by installing it, as is, and therefore the RAID apparatus does not perform a build-in of the disk B.

Incidentally, if the disk B (which has failed) is removed and the disk D (which is normal) is also removed, followed by installing the disk D in the position of the disk B, a judgment is that it is a disk having the same Disk WWN as one prior to the replacement, an installation of the disk D is accordingly not permitted. That is, the Disk WWN of a post-replacement disk is compared with the Disk WWNs of all disks registered in the RAID apparatus and, if there is an identical one, a disk having the same Disk WWN as one prior to the replacement is judged to have been installed.

However, once a build-in is complete, the Disk WWN of the pre-replacement disk is erased. Therefore, if a build-in is complete with the disk F being installed in the disk D position in the above example, followed by installing the disk D in the position of the disk B, then the build-in of the disk D is permitted.

Note that an “apparatus” represents a RAID apparatus in the following description. Meanwhile, the following outlines the above noted Disk WWN and hot swap:
Disk WWN: each disk retains a single unique-in-the-world name, thereby enabling an individual judgment of a disk.
Hot swap: a function for enabling a part replacement without stopping the operation of an apparatus.

As noted above, a how swap by using the same disk is not permitted conventionally. The rationale includes the following:

(1) If a failed disk is installed in an apparatus again, the aforementioned failed disk may adversely influence a system depending on a situation, and therefore the disk is isolated instead of being built in.

(2) It is not possible to detect, in real time, whether or not a disk is physically removed from an apparatus and installed therein, and therefore there is a possibility of an apparatus firm regarding that a disk is removed from the apparatus even if it is not actually removed therefrom. In such a case, the installation of it causes an adverse effect that a disk to be isolated is once again built in, and therefore the control is such that the isolated disk is not built in.

Meanwhile, the following disclosed techniques are known with regard to a failure of a disk apparatus:

An invention noted in a patent document 1 is a disk array apparatus capable of recovering without replacing a disk apparatus for an error in the event of an off-track of the disk apparatus reaching a measurable limit.

An invention noted in a patent document 2, aiming at a capability of obtaining failure information securely, is a disk array apparatus comprising a trace buffer for storing failure information at the time of a failure occurrence in either of physical drives, wherein the failure information stored in the trace buffer is written to a physical drive which is designated as a failure pickup-use drive.

An invention noted in a patent document 3, aiming at decreasing a frequency of disk failure occurrences per se and avoiding a risk of a data loss, comprises a mechanism for analyzing conditions of disks statistically and changing over array disks by using a normal disk before a disk failure occurs.

Patent document 1: Laid-Open Japanese Patent Application Publication No. 09-167427

Patent document 2: Laid-Open Japanese Patent Application Publication No. 11-353127

Patent document 3: Laid-Open Japanese Patent Application Publication No. 2000-305720

As noted above, although a hot swap of a disk is carried out in the case of a disk failure occurrence, a hot swap by the same disk is conventionally not permitted.

However, cases constituting a disk failure include not only the case of a disk being abnormal but also the case of seemingly as such while it is an adverse effect of another component. For example, disks equipped in an apparatus are connected by fiber channels (FC), an abnormality of which sometimes looks as though a disk were abnormal. As such, even if a disk failure is not caused by a disk (i.e., even though a disk per se is not actually failed), the disk must be replaced by a new one, requiring an extraneous work, thus resulting in an actual disadvantage of a cost increase.

Meanwhile, in the case of another disk failing caused by a disk cause (which is regarded as such; however, supposing here that there is no problem in either disk per se), the replacement work requires a sequential replacement by using a maintenance-use disk, consuming a lot of work. For example, in the case that there are disks A through E and if the disks B through E are regarded as being in failure, in addition to the disk A which is the problem cause disk, first is to install a maintenance disk F to be built in, replacing the disk A and erasing a registration thereof as noted above, followed by installing the disk A in the position of the disk B. Likewise followed by replacing in sequence such as installing the disk B in the position of the disk C, and the disk C in the position of the Disk D (because a use of new disk is wasteful since no disk has actually failed).

Incidentally, none of the above noted patent documents 1 through 3 is relating to the above described problem in the case of managing by using the Disk WWN.

### SUMMARY OF THE INVENTION

The problem for the present invention, relating to a RAID apparatus for managing a hot swap by using a Disk WWN, is to provide a RAID apparatus, module therefor, et cetera, capable of eliminating the above noted disadvantage by permitting an incorporation of the same disk if a predefined condition is satisfied even in the case of carrying out a hot swap by using the aforementioned disk.

According to the present invention, a module within a RAID apparatus including a RAID group constituted by a plurality of disks comprises: a first storage unit for registering an identifier name of each of the disks; a second storage unit for storing a cause for isolating each of the disks; and a disk incorporation process unit for judging whether or not a predefined series of conditions are satisfied by referring to the second storage unit and carrying out an incorporation process for an installed disk if the conditions are satisfied even in the case of an identifier name registered in the first storage unit being identical with that of the installed disk when detecting the facts of a discretionary one of the disks having been isolated and a discretionary disk having been installed.

Conventionally, if an identifier name and that of an installed disk are identical, that is, if an isolated disk is reinstalled, the aforementioned disk has never been built in without an exception.

Contrarily, the above noted module according to the present invention is contrived to permit an incorporation and carry out an incorporation process even if the same disk is reinstalled only in the case of satisfying a prescribed condition based on a content of error occurring in the above noted each disk, a state of the above noted each disk and a cause for isolating the above noted each disk. The case of satisfying a prescribed condition is defined as the case of a conceptually low possibility of a problem arising if the isolated disk is reinstalled, e.g., the above described case of a disk failure not caused by the disk per se.

In the above noted module, however, the disk incorporation process unit does not permit a reincorporation of the installed disk regardless of the conditions being satisfied, if the disk is isolated within a predefined period of time following a carry-out of an incorporation process for the disk.

Note that the present invention is not limited to the configuration of the above noted module, but can be comprised as a method therefor, a program, or a RAID apparatus, comprising the above noted module.

The RAID apparatus, the module therefor, et cetera, relating to the RAID apparatus managing a hot swap by using an identifier name, are contrived to permit an incorporation of the same disk if a predefined condition is satisfied even in the case of a hot swap by using the aforementioned disk being performed. This configuration solves the above noted problems of taking an extraneous work and a cost increase associated with replacing with a new disk.

### BRIEF DESCRIPTION OF THE DRAWINGS

FIGS. 1A and 1B each is a diagram exemplifying a conventional hot swap;

FIG. 2 is a diagram of a common configuration of a RAID apparatus;

FIG. 3 is diagram of a hardware configuration of a centralized module (CM) shown in FIG. 2;

FIG. 4 is a functional block diagram of the CM shown in FIG. 2;

FIG. 5 is a diagram exemplifying a structure of a common table;

FIG. 6 is a flow chart of a disk incorporation process unit according to a first embodiment;

FIG. 7A is a diagram exemplifying an FC system error; FIG. 7B is a diagram showing a specific example of a “disk isolation factor”; and

FIG. 8 is a process flow chart of a disk incorporation process unit according to a second embodiment.

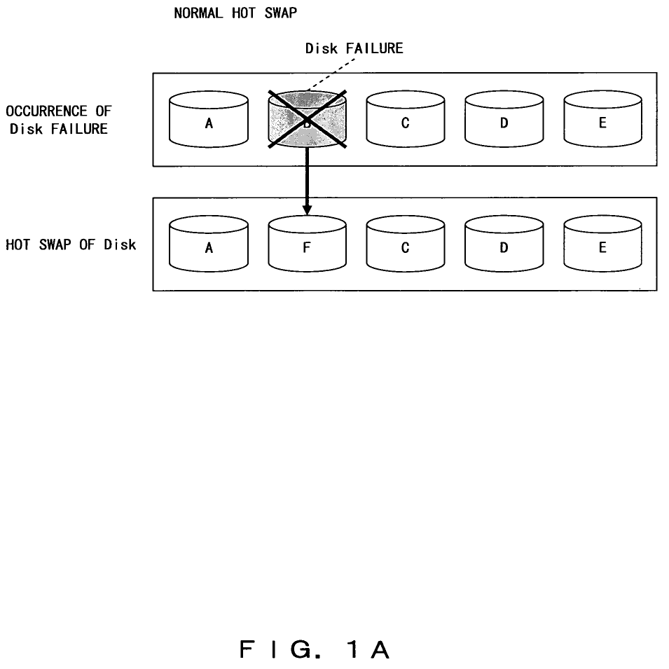

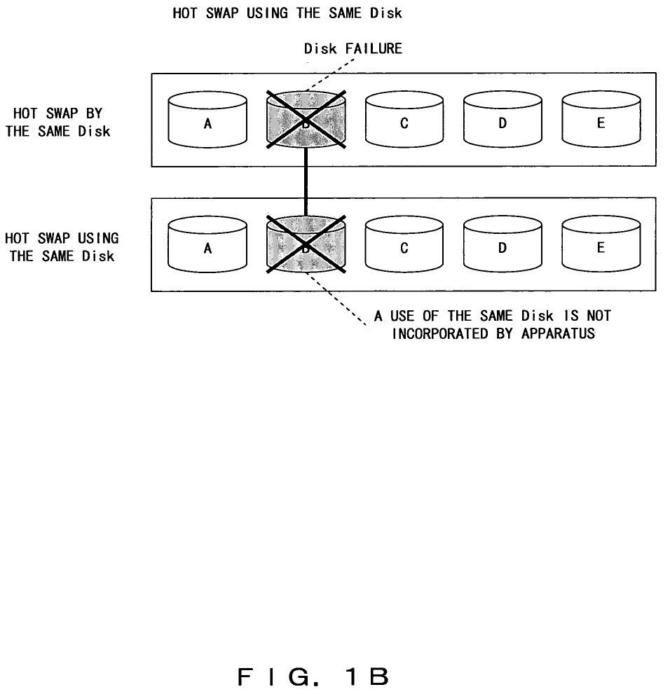

### DESCRIPTION OF THE PREFERRED EMBODIMENTS

The following is a description of the preferred embodiment of the present invention by referring to the accompanying drawings.

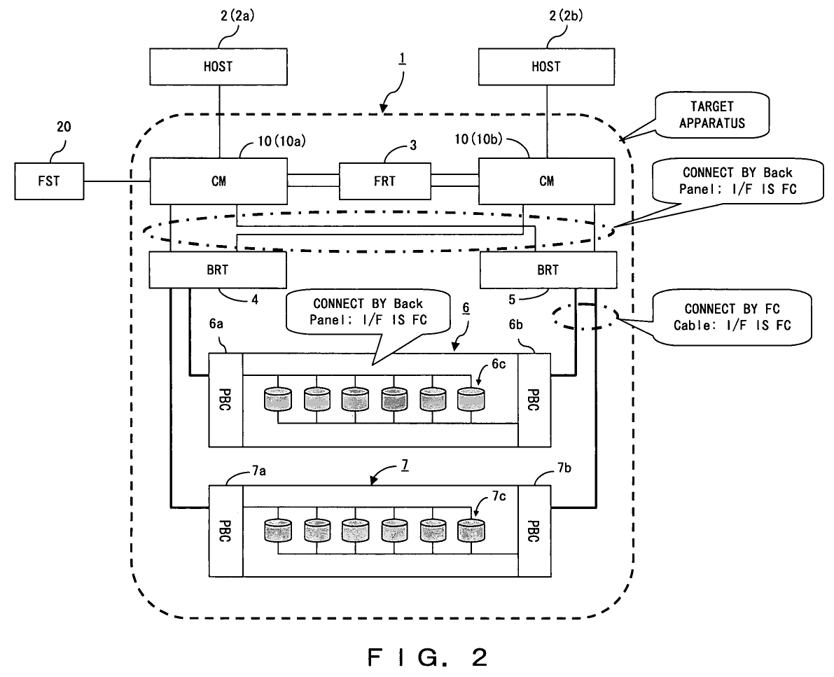

FIG. 2 is a diagram of a common configuration of a RAID apparatus.

The shown RAID apparatus 1 comprises two Centralized Modules (CM) 10 (i.e., 10a and 10b), a FRT 3, Backend Routers (BRT) 4 and 5, and Drive Enclosures (DE) 6 and 7.

The CM 10 manages/controls various access and error recovery processes within the RAID apparatus 1. The BRTs 4 and 5 are positioned between the CMs 10 and DEs 6 and 7, and perform the roles of switches connecting the CM 10 and each DE (i.e., disk groups). There are two paths for a host 2 to access a discretionary DE by way of the CM 10. These two access paths are respectively equipped with the BRTs 4 and 5. Therefore, even if either of the access paths becomes unusable by a certain cause (e.g., a BRT failure, et cetera), an access is enabled by using the other access path.

Here, the CM 10a is connected to both of the systems of the BRT 4 and BRT 5, and likewise is the CM 10b connected. Note that a later described reincorporation appropriateness judgment process, et cetera, is carried out by the CM 10a and CM 10b individually. The FRT 3 is disposed for relay-controlling communications between the CMs 10a and 10b.

The DE 6 includes port bypass circuits (PBCs) 6a and 6b, and a disk group 6c. The DE 7 likewise includes PBCs 7a and 7b, and a disk group 7c. The PBC is hardware having the function of making a certain abnormal disk bypassed from a loop (i.e., the function of isolating the disk) in order to prevent the disk from becoming a “dam” in the loop when an abnormality occurrs to the disk in an FC transmission path formed by the loop. The PBC notifies the CM 10 of the isolated disk.

Each port of the BRT 4 is connected to the PBC 6a and PBC 7a, while each port of the BRT 5 is connected to the PBC 6b and PBC 7b, and each of the CM 10s accesses the disk groups 6c and 7c by way of the BRT 4 or BRT 5 and PBC.

Each of the CMs 10 is connected to the hosts 2 (i.e., 2a and 2b) by way of a random telecommunication line.

Each of the CMs 10 is also connected with an FST 20 on an as required basis (e.g., for maintenance and repair works). The FST 20 is a specific maintenance-use personal computer (PC) An operator (e.g., a maintenance technician, et cetera) operates the FST 20 on an as required basis to instruct the CM 10 for isolating a discretionary disk.

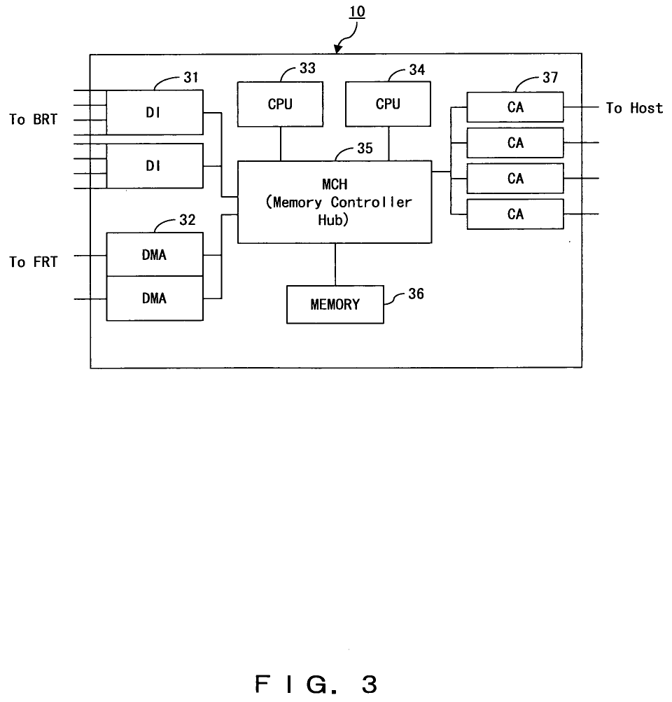

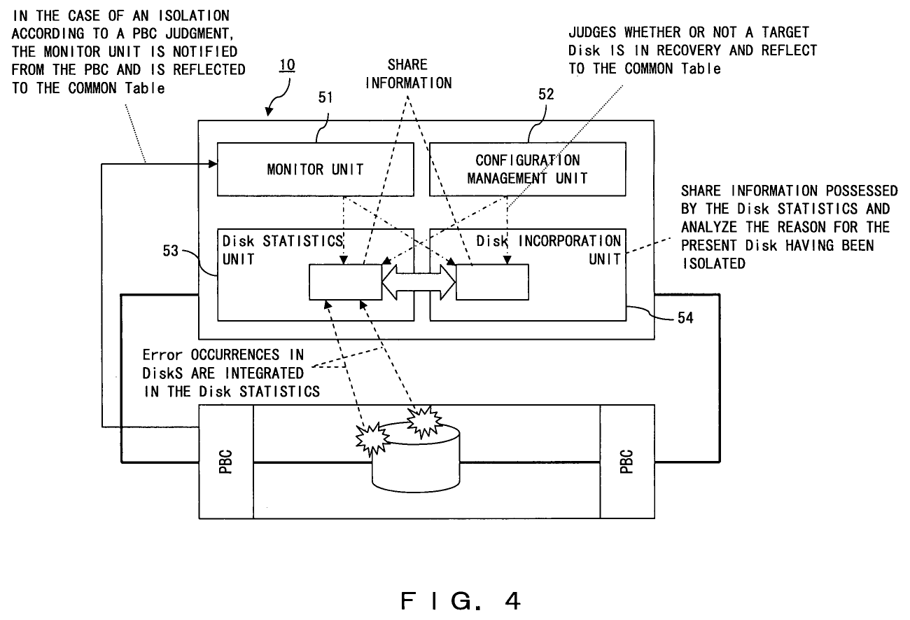

FIG. 3 shows a diagram of a hardware configuration of the above noted CM 10.

The CM 10 shown in FIG. 3 comprises individual DIs 31, individual direct memory accesses (DMAs) 32, two Central Processing units (CPUs) 33 and 34, a Memory Controller Hub (MCH) 35, memory 36 and individual channel adaptors (CAs) 37.

The DIs 31 are FC controllers connecting to respective BRTs. The DMA 32 is a telecommunication line connecting to the FRT 3. The MCH 35 is a circuit connecting the so-called host side bus, such as external buses of the CPUs 33 and 34, to a peripheral interconnect (PCI) bus for enabling intercommunications. The CAs 37 are adaptors for connecting to the respective hosts.

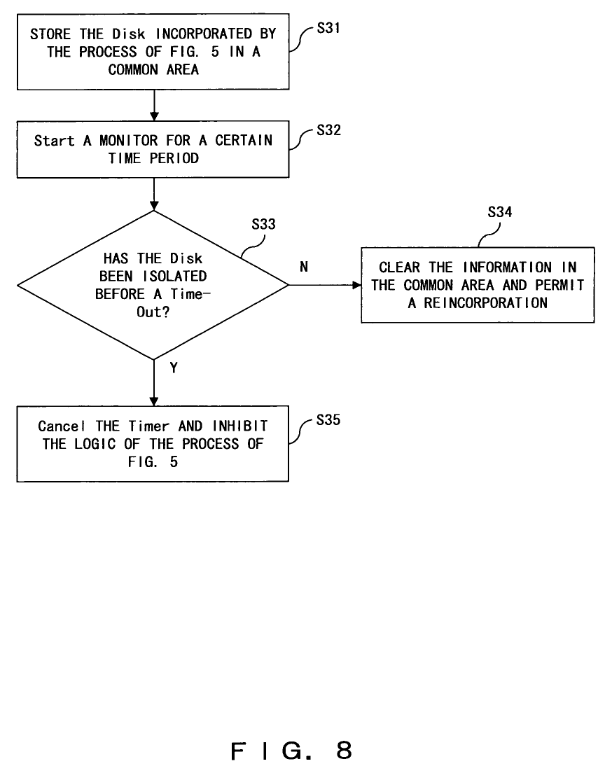

Later described processes of various flow charts shown in FIGS. 6 and 8, and functions of various function units shown in FIG. 4, are accomplished by the CPU 33 or CPU 34 reading an application program stored in memory 36 and executing it. A later described common table 60, et cetera, are also stored in the memory 36.

FIG. 4 is a functional block diagram of the CM 10.

The CM 10 comprises a monitor unit 51, a configuration management unit 52, a disk statistics unit 53 and a disk incorporation unit 54. Among these, the functions of the monitor unit 51, configuration management unit 52 and disk statistics unit 53 may be approximately the same as a conventional technique (whereas the difference lies in the aspect of reflecting data respectively detected and managed by the units to the common table 60). The characteristic of the CM according to the present embodiment lies in the disk incorporation unit 54. Although a functional unit for judging an appropriateness of disk incorporation has conventionally existed, there has been the above noted problem because its judgment only used to utilize a Disk WWN as described above.

Having received a notification from the PBC as described above in the event of isolating according to a judgment of the PBC, the monitor unit 51 sets it to a PBC cause 63 of the later described common table 60. The configuration management unit 52 judges whether or not the respective disks are in recovery (i.e., in a rebuild/copyback state) and sets the judgment result to a later described recovery in-progress 64 of the common table 60.

Meanwhile, information of an error occurring in each disk is integrated in the disk statistics unit 53. That is, the disk statistics unit 53 is a module disposed for performing the processes of counting up a point corresponding to an error phenomenon for every occurrence of the error for each disk equipped in the RAID apparatus 1, and isolating a disk of which the count-up value exceeds a threshold value.

And in the case of isolating a disk, the disk statistics unit 53 according to the present embodiment sets a cause for isolating (noted as “isolation cause” hereinafter) the disk to an isolation cause 61 of the common table 60. There are two kinds of isolation causes, i.e., a device system error and an FC system error. The difference between the device system error and FC system error is that the former is a hardware-wise abnormality and the latter is an error in a view point of the FC loop. The disk statistics unit 53 further sets a disk isolation factor, as detailed information of the isolation cause, to a factor 65 of the common table 60. The disk isolation factor includes for example an isolation based on a disk statistics, an isolation due to a forced degeneration, an isolation due to “disk not ready”, et cetera.

The disk incorporation unit 54, sharing information managed by the disk statistics unit 53, judges whether or not to permit a reincorporation of the isolated disk by referring to the common table 60. Note that the disk incorporation unit 54 first judges by a Disk WWN as in the conventional technique. Therefore, if a Disk WWN of a disk installed after isolating a discretionary disk is different from the registered Disk WWNs (i.e., in the case of installing a new disk such as a maintenance-use disk, et cetera), it of course permits the incorporation. Contrarily, if a Disk WWN of a disk installed after isolating a discretionary disk is the same as a registered Disk WWN (i.e., in the case of carrying out a hot swap by using the above noted same disk), an incorporation has conventionally not been permitted without an exception, whereas the present method may sometimes permit an incorporation by making a judgment as shown in the following.

<A Judgment Method for Whether or not to Permit a Reincorporation of an Isolated Disk Once from an Apparatus>

(1) Basically done is to permit a reincorporation and carry out an incorporation process only if all of the following conditions 1 through 4 are satisfied. However, all these conditions are not necessarily satisfied, although a possibility of a problem occurrence as a result of reincorporating the isolated disk is considered to be extremely low if all the conditions are satisfied:

Condition 1: the isolation cause is not a device system error (i.e., not a hardware-wise failure of a disk)

Condition 2: in the case of an FC system error (i.e., a disk transmission path error), a judgment is made as to whether or not to permit an incorporation according to a category of the FC error. That is, a reincorporation is not permitted if either of the following conditions is not satisfied:
not recovery in progress (i.e., in a rebuild/copyback state) (that is, a recovery failure disk due to an FC system error (i.e., a disk of rebuild/copyback in progress) is not incorporated in order to prevent a delay of the rebuild/copyback process)
not an isolation according to a statistical count-up of points of the apparent disk cause

Condition 3: not an isolation according to a PBC judgment (i.e., a reincorporation of a disk autonomously isolated by the PBC is not permitted)

Condition 4: the above noted “disk isolation factor” is a factor of an incorporation target (i.e., the “disk isolation factor” is referred to and if it is a factor of a incorporation target, a reincorporation is permitted and it is carried out)

(2) In the case of carrying out a reincorporation, the disk incorporation unit 54 monitors the disk statistics unit 53 for a certain time period after the incorporation and, if there is a point being added to other disks, isolates the aforementioned disk by determining that the incorporated disk is the cause. In other words, it-monitors a statistics of the FC transmission path in which a disk is incorporated for a certain time period after a reincorporation and, if a point is added to the transmission path, isolates the aforementioned disk as a suspect disk. Incidentally, the above noted “other disks” is defined as all disks existing in the same loop as the incorporated disk for example.

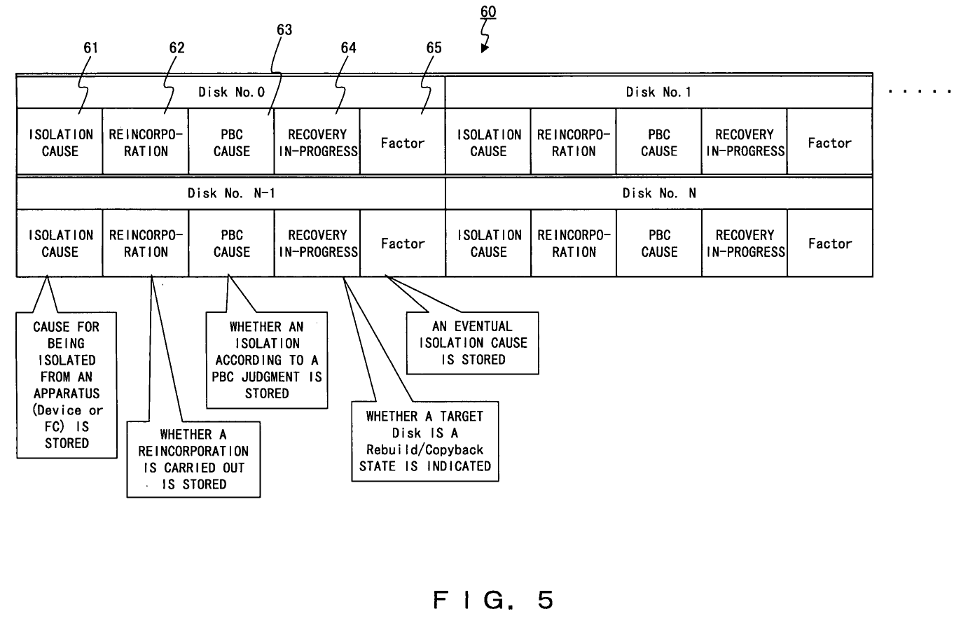

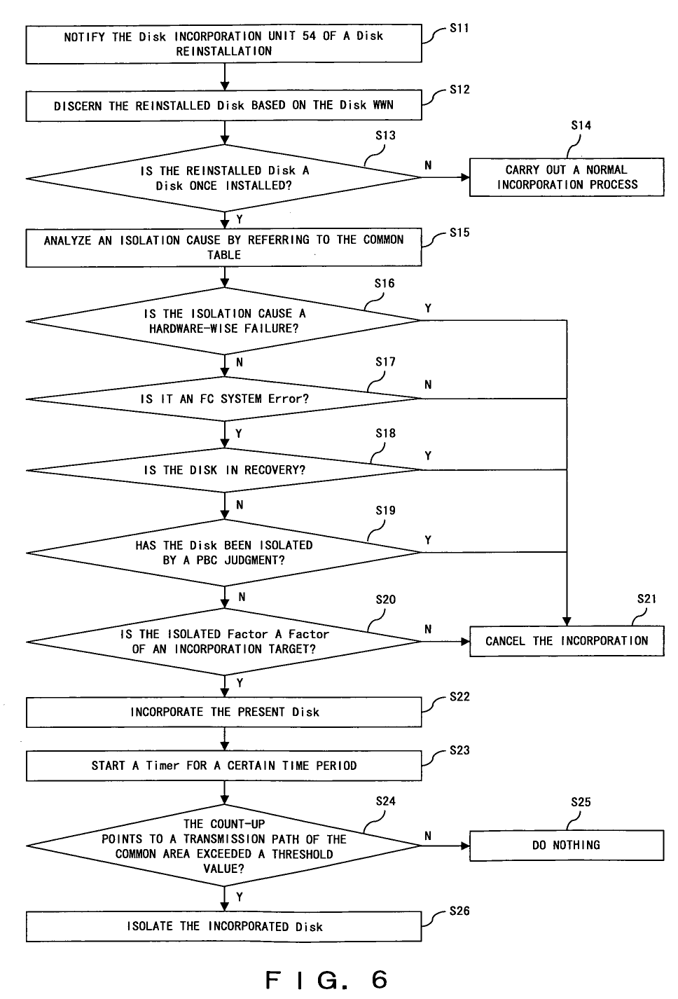

FIG. 5 is a diagram exemplifying a structure of the above noted common table.

The common table 60 shown in FIG. 5 is furnished with storage areas for storing various kinds of information such as the above noted isolation cause through factor for each disk, and the stored data are cleared at the time of a disk replacement.

The common table 60 shown in the diagram stores an isolation cause 61, a reincorporation 62, a PBC cause 63, a recovery in-progress 64 and a factor 65, all for each disk.

The information other than the factor 65, i.e., the isolation cause 61, reincorporation 62, PBC cause 63 and recovery in-progress 64, each is one bit flag information for example.

The isolation cause 61 is set by a judgment of the disk statistics unit 53 as to whether the present disk has been isolated by a device system error (i.e., a hardware-wise breakdown) or an FC system error (i.e., an abnormality in the transmission path). An example setup is “1” for a device system error and “0” for an FC system error.

The reincorporation 62 is set, for example, at “1” by the disk incorporation unit 54 in the case of the present disk having been reincorporated. It is cleared to “0” when a certain time period elapses following being set at “1”.

The PBC cause 63 is set, for example, at “1” by the monitor unit 51 according to a notification from the PBC in the case of carrying out an isolation of the present disk based on a PBC judgment.

The recovery in-progress 64 is set, for example, at “1” by the configuration management unit 52 in the case of a rebuild/copyback being in operation prior to a reincorporation relating to the present disk (that is, the present disk is in the process of recovery).

In the factor 65, an eventual isolation cause (e.g., an error code such as a later described “0x0028”, et cetera) is set by a judgment of the disk statistics unit 53. That is, the above noted “disk isolation factor” is set.

Incidentally, a Disk WWN of each of the currently equipped disks is also stored while it is not specifically shown herein.

FIG. 6 is a flow chart of the disk incorporation process unit 54. This process is according to the first embodiment.

Having detected that a discretionary disk has once been isolated followed by being connected, the PBC, et cetera, for example, reads a Disk WWN of the disk (called as “target disk” hereinafter) and notifies the disk incorporation unit 54 of the Disk WWN (step S11) (simply noted as “S11” hereinafter). The disk incorporation unit 54 carries out the processes of the S12 and thereafter.

That is, it first compares the notified Disk WWN with the stored Disk WWNs (S12) and, if they are not identical, that is, if a disk different from the isolated disk is installed for example (“no” for S13), carries out a normal incorporation process (S14). Contrarily, if the Disk WWNs are identical, that is, if the isolated disk is reinstalled (“yes” for S13), it carries out the processes of the S15 and thereafter.

It carries out the processes of the S15 and thereafter by referring to various kinds of information stored in the common table 60 relating to the reinstalled target disk.

That is, as it is possible to know whether the isolation cause of the target disk is a device system error (i.e., a hardware-wise breakdown of the disk itself) or FC system error (i.e., an abnormality in the transmission path) by referring to the isolation cause 61 to begin with; if the cause is the device system error (“yes” for S16), the disk incorporation unit 54 cancels an incorporation process for the target disk (i.e., a reincorporation is not permitted) (S21).

Comparably, if the isolation cause of the target disk is an FC system error (i.e., an abnormality in the transmission path) (“yes” for S17), if the state of the target disk is “in recovery” (i.e., the recovery in-progress 64 is “1” for example) (“yes” for S18), it cancels an incorporation process for the target disk (i.e., a reincorporation is not permitted) (S21)

Then, if the target disk has been isolated according to a PBC judgment (i.e., the PBC cause 63 is “1” for example) (“yes” for S19), or if the “disk isolation factor” (refer to the factor 65) is not an “incorporation target factor” (“no” for S20), it also cancels an incorporation process for the target disk (i.e., a reincorporation is not permitted) (S21).

Incidentally, the disk isolation factor is described later by showing a specific example. Note that the case of the judgment of the S19 being “no” (i.e., not a case of an isolation according to a PBC judgment) includes, for example, an event of an operator (i.e., a maintenance technician, et cetera) operating the FST 20 to instruct the CM 10 for the isolation of the target disk or that of isolating it according to a CM 10 judgment.

With an exception of judging as a cancellation of the reincorporation process (i.e., the reincorporation being not permitted), it permits and carries out the incorporation process for the present target disk (S22).

Then, having completed the incorporation of the target disk, the disk incorporation unit 54 starts a timer which shifts to a time-out in a predetermined length of time (S23). And it monitors the disk statistics unit 53 (i.e., monitors a situation of the above noted counting of points by the disk statistics unit 53) until the timer shits to a time-out, judges whether or not the count-up points added to other disks exceed a preset second threshold value and, if the points exceed the threshold value (“yes” for S24), carries out an isolation process for the incorporated disk (S26). Comparably, if the timer shifts to a time-out before the count-up points to other disks exceed the threshold value (“no” for S24), it does nothing (S25). Note that the second threshold value used in the above described step S24 is one different from the threshold value (which is called a “first threshold value”) for judging whether the above described isolation is to be carried out (that is, the second threshold value is smaller than the first threshold value).

As described above, the process according to the first embodiment permits the incorporation if all the conditions shown in the above described steps S16 through S20 are satisfied even in the case of the same disk having been reinstalled. In other words, an incorporation of the same disk is permitted if the cause of a disk failure or a situation at the event thereof is considered to create no problem associated with the reinstallation of the same disk. However, the configuration is such that a monitor is performed for a certain period of time after the reincorporation because the incorporated disk may adversely affect other disks, and the disk is isolated again if there is a problem.

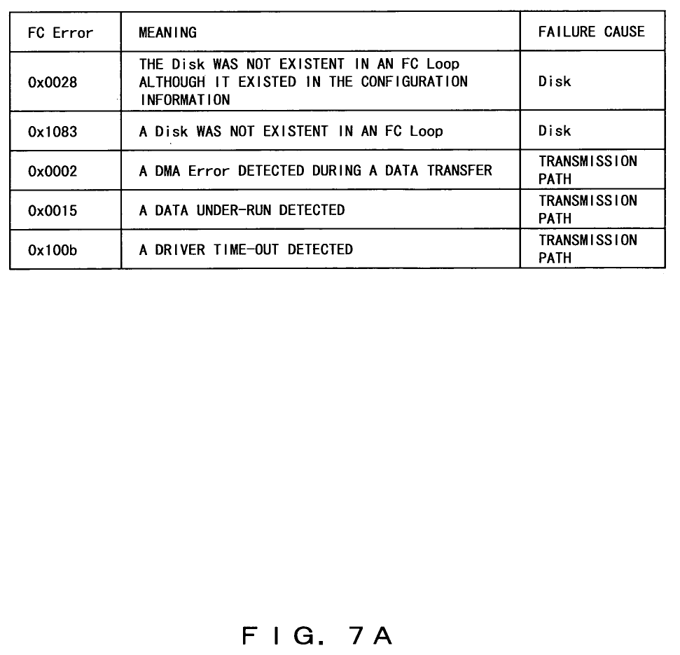

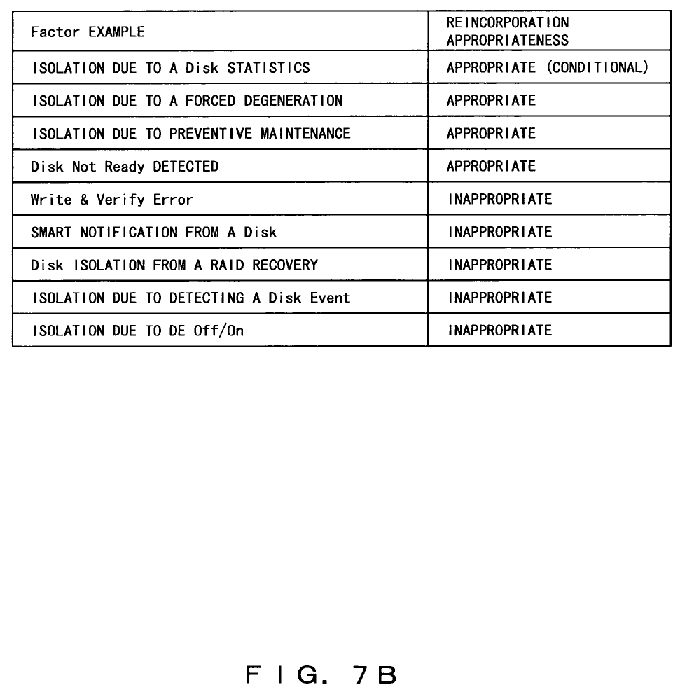

FIG. 7A exemplifies an FC system error.

The “0x0028”, “0x100b”, et cetera, are error codes of the FC system errors of which the meanings and fault causes are shown in a list thereof as shown in FIG. 7A.

The error code “0x0028” means that “the disk was not existent in an FC loop although it existed in the configuration information”, and the error code “0x1083” means that “a disk was not existent in an FC loop”. These two errors are examples of the above noted “FC system error (i.e., an error on a disk transmission path) but is apparently a disk cause error”.

Note that FIG. 7A also shows an example of the FC system error of which the failure cause is a transmission path, for reference. That is, the error code “0x0002” means that “a DMA error detected during a data transfer”, the error code “0x0015” means that “a data under-run” detected”, and the error code “0x10b” means that “a driver time-out detected”.

FIG. 7B shows a specific example of the above noted “disk isolation factor”. The factor of which the “reincorporation appropriateness” is “appropriate” shown in FIG. 7B is the above noted “incorporation target factor”. That is, examples shown in the chart, i.e., “isolation due to a disk statistics”, “isolation due to a forced degeneration”, “isolation due to a preventive maintenance” and “disk not ready”, are the above noted “incorporation target factor”. The individual factors other than these factors do not constitute the above noted “incorporation target factor” in the examples shown in the chart, and therefore an incorporation is not permitted even though other conditions are satisfied.

That is, the respective factors, i.e., “Write & Verify Error”, “SMART notification from a disk”, “disk isolation from a RAID recovery”, “isolation due to detecting a Disk Event” and “isolation due to DE Off/On” in the examples shown in the chart do not constitute the above noted “incorporation target factor”.

The next is a description of a second embodiment.

FIG. 8 shows a process flow chart of a disk incorporation process unit according to the second embodiment.

The second embodiment premises an execution of a certain process immediately after the judgment of the S13 shown in FIG. 6 being “yes”. That is, premising the execution of the process of “referring to the reincorporation 62 of the common table 60 and, if it is “1” (meaning that the present disk is reincorporated), “the incorporation is canceled” immediately instead of shifting to the S15”. Moreover, if the judgment of the above noted S24 is “no”, the disk incorporation unit 54 sets “1” to the reincorporation 62 instead of doing nothing (S31).

Then it starts a timer (called as “monitor timer” hereinafter) different from the timer of the above noted S23 (S32). A set time of the monitor timer is basically longer than that of the timer of the S23.

Then, in the case of the reincorporated disk having been isolated again before the monitor timer shifts to a time-out (“yes” for S33), it carries out the process of FIG. 6; however, the judgment becomes that “the incorporation is canceled” by the above noted added process since the reincorporation 62 remains as being set as “1” in the S31. That is, the judgment of “the incorporation is canceled” is forced, in lieu of applying the judgment logic of FIG. 6 (S35).

Contrarily, if the monitor timer shifts to time-out without the reincorporated disk being isolated again (“no” for S33), it clears the reincorporation 62 to “0” (S34). In this case, the judgment logic of FIG. 6 is applied in lieu of being judged as “the incorporation is canceled” forcibly, even if the reincorporated disk is isolated again thereafter.

The RAID apparatus, module therefor, etcetera, according the present invention, relating to a RAID apparatus managing a how swap by using a Disk WWN, is contrived to permit the incorporation of the same disk if a predefined condition is satisfied even in the case of a hot swap being performed by the aforementioned disk, thus solving the above described problem of taking an extraneous work and increasing a cost in the event of replacing with a new disk.

What is claimed is:

1. A module within a Redundant Array of Inexpensive Disks (RAID) apparatus including a RAID group constituted by a plurality of disks, comprising:
a first storage unit for registering an identifier name of each of the disks;
a second storage unit for storing a cause for isolating each of the disks; and
a disk incorporation process unit for judging whether or not a predefined series of conditions are satisfied by referring to the second storage unit and carrying out an incorporation process for an installed disk if the conditions are satisfied even in the case of an identifier name registered in the first storage unit being identical with that of the installed disk when detecting the facts of a discretionary one of the disks having been isolated and a discretionary disk having been installed.

2. The module according to claim 1, further comprising
a disk statistics unit for carrying out the processes of counting up a point corresponding to a phenomenon of an error for each occurrence of the error by each of said disks, and isolating a disk of which the count-up result of points exceeds a preset first threshold value, wherein
said disk incorporation process unit monitors a count-up situation by the disk statistics unit for a certain period of time following the carry-out of an incorporation process for said installed disk, and isolates the aforementioned disk if a count-up result of points for a disk other than the installed disk exceeds a preset second threshold value.

3. The module according to claim 1, wherein said predefined series of conditions includes at least a condition of said cause for isolating said disk being not a cause of the disk itself hardware-wise.

4. The module according to claim 3, wherein
said predefined series of conditions are further added by a condition of a detail factor being a “factor of an incorporation target”.

5. The module according to claim 3, wherein
said second storage unit further stores information, for each of said disks, indicating whether or not an isolation has been performed according to a judgment of a port bypass circuit (PBC), and
said predefined series of conditions are further added by a condition of said isolated disk having not been isolated according to a judgment of the PBC.

6. The module according to claim 3, wherein
said second storage unit further stores information indicating whether or not a state of each of the said disks is in recovery, and
said predefined series of conditions are further added by a condition of a state of said isolated disk being not in recovery.

7. The module according to claim 1, wherein
said disk incorporation process unit does not permit a reincorporation of said installed disk regardless of said conditions being satisfied, if the disk is isolated within a predefined period of time following a carry-out of an incorporation process for the disk.

8. A Redundant Array of Inexpensive Disks (RAID) apparatus, including:
a RAID group constituted by a plurality of disks; and
a module for collecting, and managing, contents of an error occurring in each of the disks, and also carrying out an incorporation process for a discretionary disk, wherein
the module comprises:
a first storage unit for registering an identifier name of each of the disks;
a second storage unit for storing a cause for isolating each of the disks; and
a disk incorporation process unit for judging whether or not a predefined series of conditions are satisfied by referring to the second storage unit and carrying out an incorporation process for an installed disk if the conditions are satisfied even in the case of an identifier name registered in the first storage unit being identical with that of the installed disk when detecting the facts of a discretionary one of the disks having been isolated and a discretionary disk having been installed.

9. A disk incorporation appropriateness judgment method used for a controller module within a Redundant Array of Inexpensive Disks (RAID) apparatus comprising a RAID group constituted by a plurality of disks, carrying out
an incorporation process for an installed disk if a predefined condition is satisfied even in the case of a stored identifier name of each of the disks being identical with that of the installed disk when detecting the facts of a discretionary one of the disks having been isolated and a discretionary disk having been installed.

10. A program for making a computer used for a Redundant Array of Inexpensive Disks (RAID) apparatus comprising a RAID group constituted by a plurality of disks, wherein
the program makes the computer execute the function of carrying out
an incorporation process for an installed disk if a predefined condition is satisfied even in the case of a stored identifier name of any of the disks being identical with that of the installed disk when detecting the facts of a discretionary one of the disks having been isolated and a discretionary disk having been installed.
